(19) United States
(12) Patent Application Publication
(10) Pub. No.: US 2026/0167796 A1
(43) Pub. Date: Jun. 18, 2026

(54) VALUE CHAIN RETURN PROCESS FOR THE RECOVERY AND OF POLYMERIC METHYLENE PHENYLENE AMINE (PMDA) AS ITS HCI SALT FROM THE DEPOLYMERIZATION OF SPEND POLYURETHANE AND POLYISOCYANURATE RIGID FOAMS

(71) Applicant: BASF SE, Ludwigshafen am Rhein (DE)

(72) Inventors: Thomas SCHAUB, Ludwigshafen am Rhein (DE); Markus SCHUETTE, Lemfoerde (DE); Torsten MATTKE, Ludwigshafen am Rhein (DE); A. Stephen K. HASHMI, Heidelberg (DE); Philippe KLEIN, Heidelberg (DE)

(73) Assignee: BASF SE, Ludwigshafen am Rhein (DE)

(21) Appl. No.: 19/126,780

(22) PCT Filed: Nov. 2, 2023
(86) PCT No.: PCT/EP2023/080534

§ 371 Date: May 2, 2025

(30) Foreign Application Priority Data
Nov. 3, 2022 (EP) 22205387.8

(51) Int. Cl. C08J 11/28

(52) U.S. Cl. CPC C08J 11/28; C08J 2375/08

(57) ABSTRACT

The present invention is directed to a value chain return process comprising the depolymerization of a polyurethane and polyisocyanurate rigid foam based on polymeric methylenediphenyl diisocyanate (pMDI) to give a mixture (M1); distillative removal of volatile compounds from mixture (M1) to give a mixture (M2) comprising pMDA and at least one polyol; dissolution of the mixture (M2) in an aprotic organic solvent (S1) with a dipol moment in the range from 0.5*10-30 Cm to 7.8*10-30 Cm; and subsequent addition of HCl and separation of the pMDA-HCl salt. The present invention is also directed to the polymeric methylene phenylene amine (pMDA) and the polymeric methylenediphenyl diisocyanate (pMDI) obtained or obtainable according to said process as well as the use thereof for the preparation of polyurethanes or polyisocyanurates.

The present invention relates to a value chain return process for polyurethane rigid foams which allows for the recovery of polymeric methylene phenylene amine as it's HCl salt from the depolymerization of spend polyurethane rigid foams to be reused as stating material in the synthesis in polymeric methylene phenylene isocyanate (pMDI) for the synthesis of new polyurethane rigid foams.

In particular, the present invention is directed to a value chain return process comprising the depolymerization of a polyurethane and polyisocyanurate rigid foam based on polymeric methylenediphenyl diisocyanate (pMDI) to give a mixture (M1); distillative removal of volatile compounds from mixture (M1) to give a mixture (M2) comprising pMDA and at least one polyol; dissolution of the mixture (M2) in an aprotic organic solvent (S1) with a dipol moment in the range from 0.5*10⁻³⁰ Cm to 7.8*10⁻³⁰ Cm; and subsequent addition of HCl and separation of the pMDA-HCl salt. The present invention is also directed to the polymeric methylene phenylene amine (pMDA) and the polymeric methylenediphenyl diisocyanate (pMDI) obtained or obtainable according to said process as well as the use thereof for the preparation of polyurethanes or polyisocyanurates.

In the last three decades, there has been an enormous increase in worldwide plastics demand. For example, in the last 10 years, the amount of plastics produced worldwide has increased by almost 50%. Within 30 years, it has even almost quadrupled reaching an amount of 359 million metric tons in 2018. From these facts, it becomes clear that production of said huge amounts of plastics is followed by a need to dispose or recycle spent plastics. Preference should be given to recycling as thereby valuable materials, e.g. compounds which can act as monomers, can be added back to the value chain, e.g. by direct re-use in plastics production. Plastics are used with additive components incorporated for the purpose of imparting various functions to the resins. For example, as resins have high combustibility by themselves, the resins are mixed with flame retardants in a proportion of up to 25% by weight from the viewpoint of preventing the spread of fire. The possibility of returning flame retardants into the industrial cycle appears to be promising both with respect to saving of resources and from an economic point of view.

In addition, in the industrial production of polyurethane rigid foams, polyurethane (PU) rigid foam wastes are incurred. For example, such waste of PU rigid foam is obtained upon casting blocks of PU rigid foam, followed by cutting, trimming or sizing said blocks to obtain the desired PU workpiece. Additionally, rejects of PU rigid foams such as off-spec products are incurred.

Disposal of waste products, e.g. by combustion, has a negative impact on the environment as well as on the carbon footprint.

In order to reduce the waste and reduce the negative impact on the environment, there is a need to develop processing techniques to recover materials from plastic waste. The recycling process should preferably reduce both the waste of material and the carbon footprint. Further, it should be an economical and energy efficient process delivering valuable materials which comprise high technical features.

Among the plastics mentioned above, polyurethanes (PU) are important representatives. Generally, polyurethanes are produced by polyaddition of (poly)isocyanates with polyol. The characteristic chain link is the urethane group. Polyurethane exists in many types, e.g. as foams, elastomers, or thermosets, among which foams are especially important.

The polyaddition of (poly)isocyanates with polyol results in the formation of linear, branched, or cross-linked polyurethanes. As an alternative to alcohols, the most important group of NCO-reactive compounds are amines resulting in the formation of di- or trisubstituted ureas. Ureas are also formed by the reaction of water with isocyanates, in which the carbamic acid formed in the first step of the reaction spontaneously decomposes to an amine with elimination of carbon dioxide. This amine then reacts with excess isocyanate to yield symmetrically substituted ureas. This reaction is the basic reaction leading to polyurethane foams.

These foams may be formed in wide range of densities and may be of flexible, or rigid foam structures. Generally speaking, “flexible foams” are those that recover their shape after deformation. In addition to being reversibly deformable, flexible foams tend to have limited resistance to applied load and tend to have mostly open cells. “Rigid foams” are those that generally retain the deformed shape without significant recovery after deformation. Rigid foams tend to have mostly closed cells. Whether PU soft foams or PU rigid foams are formed during polyaddition mainly depends on the types of polyisocyanate and polyol components used. For example, the starting materials may influence the crosslinking of the polymers meaning that the polymer consists of a three-dimensional network. Long, flexible segments, contributed by the polyol, result in the formation of PU soft foams. PU rigid foams are obtained from short chains with many crosslinks. More details for the polyurethane rigid foams suitable to be used according the invention can be found in: Kunststoffhandbuch, Band 7, Polyurethane, Carl-Hanser-Verlag, 3. Auflage, 1993, Kapitel 6. For the rigid foams, pMDI frequently is used as the polyisocyanate component.

Polyurethane rigid foams provide excellent insulation properties. Thus, they are of great importance in the construction sector and commonly used as insulation materials, e.g. for buildings insulations or for refrigerators.

The recycling of polyurethane rigid foams to valuable monomeric compounds still remains challenging. In principle the polyurethane can be depolymerized to the polyol compound and polyamine compound by glycolysis or hydrolysis (see: Plastics recycling and Polyurethanes, in Ullmann's Encyclopedia of Industrial Chemistry, 2020, DOI: 10.1002/14356007.a21_057.pub2 and Waste Management, 2018, 76, 147-171). Isolation of the polyol and amine component in the glycolysis or hydrolysis approaches can be achieved for example by extraction/phase splitting methods or if the PU is based on the diisocyanate MDI (methylene bis phenyl isocyanate) or TDI (toluenediisocyanate), the corresponding amines MDA (methylene bis phenyl isocyanate) and TDA (toluenediamine) have a vapor pressure which allow the separation from the polyol component via distillations under reduced pressure. Unfortunately, the extraction and phase splitting methods from the glycolysis or hydrolytic methods so failed for pMDA. It can also not be separated by distillation, as pMDA has a negligible vapor pressure.

DE 2854940A1 discloses a process for the precipitation of the toluenediamine HCl salt. This can be achieved, if the water is before removed by azeotropic distillation using toluene. Then in a fractional precipitation, by adding gaseous HCl, the toluenediamine HCl is stepwise precipitated and separated by filtration. A drawback of this approach is, that a multistep precipitation is necessary to remove the toluenediamine hydrochloride from the polyol fraction. This approach also requires an exact quantitative control on the used amount of HCl in each precipitation step as well as control of the amine content in each step. Also, it is not disclosed, that this approach can work when the amine component is a higher molecular amine compound as pMDA.

To avoid the fractional precipitation of the polyamine HCl salts, DE 3034680 discloses a process, where the majority of the diamine component from a hydrolytic polyurethane depolymerization is continuously first distilled of from the reaction mixture at temperatures above 200° C. under reduced pressure. As this removal is not complete, the remaining diamine (less than 1%) in the polyol component is then precipitated by first dissolution in toluene and addition of HCl to precipitate the diamine HCL salt. A significant drawback of this approach is, that it is only viable for diamines from the polyurethane hydrolysis with a significant vapor pressure but not with pMDA which can't be distilled of under this conditions.

Another approach is the hydrogenation of polyurethane in protic organic solvents using a hydrogenation catalysts as described in ChemSusChem, 2021, DOI: 10.1002/cssc.202101705). This is so far also the only disclosed method, where the pMDA could be isolated from the polyol component after the depolymerization of a pMDI based polyurethane rigid foam. After the hydrogenation at 50 bar hydrogenation, the reaction mixture was first purified by column chromatography to obtain a polyol fraction containing the pMDA. This was then dissolved in aqueous HCl/brine to form the pMDA HCl salt. This aqueous phase, containing the dissolved pMDA HCl salt was then extracted several times with dichloromethane to extract the polyol. Afterwards the dissolved pMDA HCl salt was neutralized with aqueous NaOH to from free pMDA dissolved in this aqueous phase which had to be isolated by a further extraction with dichloromethane. A drawback of this approach is the large consumption of organic solvents for the initial column chromatography and also as the polyol as well as the pMDA must be extracted in this system. Furthermore, stochiometric amounts of NaOH are needed to release the free pMDA before extraction.

Therefore, it would be of high economic interest to depolymerize polyurethane rigid foams containing based on pMDI in a way that the polyol and the pMDA can be obtained in a simple and efficient manner. Furthermore, it is an object of the present invention to provide a process which can be applied in an easy manner and be applied in industrial scale.

This object has been achieved by a value chain return process comprising the steps of
a) depolymerization of a polyurethane and polyisocyanurate rigid foam based on polymeric methylenediphenyl diisocyanate (pMDI) to give a mixture (M1);
b) distillative removal of volatile compounds from mixture (M1) to give a mixture (M2) comprising pMDA and at least one polyol;
c) dissolution of the mixture (M2) in an aprotic organic solvent (S1) with a dipol moment in the range from 0.5*10⁻³⁰ Cm to 7.8*10⁻³⁰ Cm;
d) addition of HCl and separation of the pMDA-HCl salt.

“Value chain return” is intended to mean that the low molecular products obtained by the process of the invention can be re-integrated in a value chain leading to polyurethanes or else be used as feedstocks in another value chain.

It has been surprisingly found that in the value chain return process according to the present invention, the pMDA can be easily separated from the polyol component in it's form of the HCl salt in a single step after the depolymerization of a pMDI based polyurethane foam after removal of volatile compounds by distillation from the depolymerization mixture followed by dissolution of the remaining polyol-pMDA mixture in an organic solvent with a dipol moment of less than 10*10⁻³⁰ Cm and adding HCl to precipitate the pMDA as it's HCl salt, separation of the pMDA-HCl salt. According to the process of the present invention, the pMDA can be separated from the depolymerization mixture and directly be reused for the synthesis of new pMDI in a simple manner with a minimum number of steps.

The process of the invention yields a polyamine comprising an amino group attached to the carbon atom to which in the initial polyisocyanate a isocyanate group was bound which is oligomeric and polymeric methylene phenylene amine The polyols commonly used for the preparation of polyurethane and polyisocyanurate rigid foams based on polymeric methylenediphenyl diisocyanate (pMDI) preferably also can be re-isolated. Thus, the process preferably further yields, e.g., polyester polyols, low molecular weight polyols such as ethylene glycol or propylene glycol, or high molecular weight polyether polyols based on glycerol, sorbitol, ethylene glycol, polypropylene glycol and polytetramethylene glycol.

The present method enables re-utilization of the pMDA in the form of it's HCl salt which may readily be converted to new polyisocyanate pMDI for example by phosgenation to be used to produce new pMDI based on spend polyurethane rigid foams. Additionally, the polyol component can also be recycled for the synthesis of new polyurethane by removing the organic solvent from the liquid phase obtained in the precipitation of the pMDA-HCl salt.

The process according to the present invention comprises steps a), b), c), and d) but may also comprise further steps. The process may for example comprise further purification steps or heat treatments. According to a further embodiment, the present invention is also directed to the process as disclosed above, wherein the process comprises further purification steps.

Suitable treatment steps are in principle known to the person skilled in the art. Suitable treatment and/or purification steps may be carried out between steps a) and b), between steps b) and c) or between steps c) and d). In the context of the present invention it is also possible that step b) is carried out directly after step a). It is also possible that step c) is carried out directly after step b). It is also possible that step d) is carried out directly after step c).

Suitable purification steps include for example washing steps and drying steps.

Therefore, according to a further embodiment, the present invention is also directed to the process as disclosed above, wherein the process comprises a step d1) d1) purification of the pMDA-HCl salt by washing with fresh solvents and/or drying under elevated temperatures and/or drying in vacuo.

According to a preferred embodiment, the process comprises a further step treating the salt obtained in step d). The pMDA-HCl salt may for example be subjected to a phosgenation step to obtain polymeric methylenediphenyl diisocyanate.

Therefore, according to a further embodiment, the present invention is also directed to the process as disclosed above, wherein the process comprises step e)
e) phosgenation of the pMDA HCl salt to obtain pMDI.

According to the present invention, it is also possible that the pMDA HCl salt is subjected to phosgenation in a mixture comprising further components such as fresh pMDA or solvents.

In the context of the present invention, it is also possible to treat the pMDA-HCl salt obtained in step d) with formaldehyde. Therefore, according to a further embodiment, the present invention is also directed to the process as disclosed above, wherein the process comprises step e*)
e*) condensation reaction of the pMDA HCl salt with formaldehyde, preferably with formaldehyde and anilin, to obtain pMDA.

According to step a), a polyurethane and polyisocyanurate rigid foam based on polymeric methylenediphenyl diisocyanate (pMDI) is depolymerized to give a mixture (M1).

According to the present invention, any a polyurethane and polyisocyanurate rigid foam based on polymeric methylenediphenyl diisocyanate (pMDI) may be used in the depolymerization.

Generally, waste foams are used as a starting material in step a) of the process of the present invention.

The polyurethane rigid foams used in the present invention are typically obtained from items produced from polyurethane rigid foams at a time after use for the purpose for which they were manufactured or polyurethane rigid foam waste from production processes. Before subjecting to step a) of the process of the present invention, the items may be subjected to mechanical comminution hat is, further sorting and bringing the items into appropriate sizes, e.g., by shredding, sieving or separation by rates of density, i.e. by air, a liquid or magnetically.

Optionally, these fragments may then undergo processes to eliminate impurities, e.g. paper labels. Depending on the composition of the polyurethane rigid foam it may be subjected to extraction to remove soluble additives as flame retardants, surfactants or catalysts to remain the pure polymeric polyurethane material prior hydrolysis to avoid the additives to be hydrolyzed or ended up in the MDA.

The properties of the foams used as starting material in the process according to the present invention may vary in broad ranges.

Generally, polyurethane rigid foams are produced by a reaction between a polyisocyanate component and a polyol component.

The properties of a polyurethane rigid foam are influenced by the types of polyisocyanate and polyol components used. For example, the starting materials may influence the crosslinking of the polymers meaning that the polymer consists of a three-dimensional network. Rigid polymers typically are obtained from short chains with many crosslinks.

According to the present invention, a polyurethane and polyisocyanurate rigid foam based on polymeric methylenediphenyl diisocyanate (pMDI) is used in step a). For a representative composition of these PU rigid foams, see WO 2015/121057 and WO 2013/139781.

Common polyols used in huge quantities are, e.g., polyester polyols, low molecular weight polyols such as ethylene glycol or propylene glycol, or high molecular weight polyether polyols based on glycerol, ethylene glycol, polypropylene glycol, polytetramethylene glycol, and polyesterpolyols.

In the embodiment of the invention, the polyurethane rigid foam is based on poly polyfunctional isocyanates based on polymeric diphenylmethane diisocyanate (MDI). Suitable diphenylmethane diisocyanates are in particular 2,2′-MDI or 2,4′-MDI or 4,4′-MDI or oligomeric MDI, which is also known as polyphenylpolymethylene isocyanate, or mixtures of two or three aforementioned diphenylmethane diisocyanates, or crude MDI, which is generated in the production of MDI, or mixtures of at least one oligomer of MDI and at least one of the aforementioned low molecular weight MDI derivatives.

According to the present invention, polymeric diphenylmethane diisocyanate (MDI) may comprise up to 80% by weight of monomeric MDI, preferably less than 50% by weight, more preferable less than 30% by weight, in particular less than 20% by weight.

Polyurethane rigid foams are frequently also made of modified polyisocyanates, i.e., products obtained by chemical reaction of organic polyisocyanates and having two or more reactive isocyanate groups per molecule. Polyisocyanates comprising ester, urea, biuret, allophanate, carbodiimide, isocyanurate, uretdione, carbamate and/or urethane groups may be mentioned in particular. This groups can also be depolymerized in the process of the invention.

Methylenedi(phenylisocyanate) (MDI)-based polyurethanes and polymeric methylenedi(phenylisocyanate)-based polyurethanes are technical polymers and produced in a large scale as for example described in Polyurethanes, in Ullmann's Encyclopedia of Industrial Chemistry, 2012, DOI: 10.1002/14356007.a21_665.pub2).

In step a) according the invention, the polyurethane rigid foam based on pMDI can be depolymerized using any suitable method, for example via a hydrolysis, preferably in the presence of a catalytic active organic nitrogen component as tertiary amines or N-heterocycles.

Therefore, according to a further embodiment, the present invention is also directed to the process as disclosed above, wherein in step a) depolymerization is achieved via a hydrolysis in the presence of a catalytic active organic nitrogen component.

The catalytic active organic nitrogen compound typically consists of a organic compound containing at least one nitrogen function according formula I or formula II

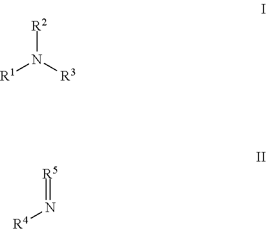

wherein R¹, and R², R³, R⁴ and R⁵ are independently of one another selected from substituted or unsubstituted C₁-C₁₂-alkyl, C₁-C₁₂-alkenyl, C₅-C₈-cycloalkyl and aryl, and two of the residues R¹, R², and R³ or R⁴ and R⁵ may form a ring or be part of a ring system.

Preferably, the active organic nitrogen compound is selected from of tertiary amines such as for example triethylamine, tributylamine, pyridine, 1-methylimdazole, dimethylbenzylamin, dicyclohexylmethylamin, dimethylcyclohexylamine, N,N,N′,N′-tetramethyldiaminodiethylether, Bis-(dimethylaminopropyl)-harnstoff, N-methyl- or N-ethylmorpholin, N-cyclohexyl-morpholin, N,N,N′,N′-tetrame¬thylethylendiamine, N,N,N,N-tetramethylbutandiamine, N,N,N,N-tetramethylhexandiamine-1,6, pentamethyldiethylentriamine, bis(2-dimethylaminoethyl)ether, dimethylpiperazin, N-dimethyl¬aminoethylpiperidin, 1,2-dimethylimidazol, 1-azabicyclo-(2,2,0)octan, 1,4-diazabicyclo.¬(2,2,2).octan (Dabco) and alkanolamine compounds such as triethanolamine, triisopropanolamine, N-methyl-und N-ethyldiethanolamine, dimethylaminoethanol, 2-(N,N-dimethylaminoethoxy)¬ethanol, N,N′,N″-tris(dialkylaminoalkyl)hexahydrotriazine, z.B. N,N′,N″-tris-(dimethylamino-propyl)-shexahydrotriazin, und triethylendiamine.

In a preferred embodiment, the active organic nitrogen compound has a boiling point below 200° C. at ambient pressure.

In a preferred embodiment, the active organic nitrogen compound is selected from pyridine, 1-methylimdazole or triethylamine.

Therefore, according to a further embodiment, the present invention is also directed to the process as disclosed above, wherein the catalytic active organic nitrogen compound is selected from the group consisting of pyridine, 1-methylimdazole and triethylamine.

According to the invention, the active nitrogen compound preferably is used in an amount of 1 to 100 weight equivalents according the polyurethane rigid foam, more preferably in an amount of 2 to 20 weight equivalents.

According to the invention, preferably water is used in combination with the active organic nitrogen compound for the hydrolysis. The water is typically used in an amount of 0.1 to 100 weight equivalents according to the polyurethane rigid foam, preferably in an amount of 1 to 10 weight equivalents.

The hydrolysis usually is carried out at a temperature in the range of 50 to 250° C., preferably in the range of from 80 and 200° C., more preferably in the range of from 100 to 180° C.

The hydrolysis usually is carried out in a pressure range of ambient pressure to 100 bar according to the vapor pressure of the water and active organic compound at the selected temperature. Preferably, the hydrolysis is carried out at 1 to 20 bar.

The time for the hydrolysis usually is selected between 0.1 and 100 hours, preferably between 2 and 50 hours, more preferably between 1 and 20 hours.

The hydrolysis can be carried out in all reactors suitable for the reaction, such as for example stirred batch reactors or tube reactors and can be run discontinuously or continuously.

According to step a), a mixture (M1) is obtained which comprises pMDA and at least one polyol and typically also comprises further volatile compounds and may also comprise unreacted starting materials. Preferable, the mixture (M1) comprises pMDA and at least one polyol and typically also comprises further volatile compounds. In case the mixture obtained in step a) comprises solid residues, theses may be separated by suitable separation steps such as for example filtration steps.

The process of the present invention further comprises step b) of distillative removal of volatile compounds from mixture (M1) to give a mixture (M2) comprising pMDA and at least one polyol; In step b) according to the invention all volatile compounds after the depolymerization are removed by distillation. Generally, the “volatility” of a liquid may be described using its vapor pressure, wherein a high vapor pressure indicates a high volatility, and vice versa. In the context of the present invention, the volatile components after depolymerization are mainly the active organic nitrogen compound and the water used in the hydrolysis.

The distillation can be carried out at pressures from 1 bar to 0.001 bar, preferably between 1 bar and 0.01 bar.

The distillation can be carried out at temperatures from 20° C. to 250° C., preferably between 50° and 200° C.

Therefore, according to a further embodiment, the present invention is also directed to the process as disclosed above, wherein step b) is carried out at a pressure in the range of from 1 bar to 0.001 bar and a temperature in the range of from 20° C. to 250° C.

The active organic nitrogen compound separated in step b) can be reused for further depolymerizations.

In step b), mixture (M2) is obtained which comprises pMDA and at least one polyol. The remaining high boiling/nonvolatile fraction in the distillation consists of the polyol-component as well as the pMDA and is further used in step c) of the present invention.

According to step c), mixture (M2) is dissolved in an organic solvent (S1) with a dipol moment of less than 10*10⁻³⁰ Cm.

In step c) according the invention the remaining polyol-pMDA mixture is taken up in an aprotic organic solvent with a dipol moment in the range from 0.5*10⁻³⁰ Cm to 7.8*10⁻³⁰ Cm, preferably in the range from 0.5*10⁻³⁰ to 6.27*10⁻³⁰ Cm.

Suitable solvents are in principle known. According to the present invention, it has been found that the aprotic organic solvent (S1) with a dipol moment in the range from 0.5*10⁻³⁰ Cm to 7.8*10⁻³⁰ Cm is suitable to dissolve at least the polyol component but will not dissolve the pMDA-HCl salt. For an economic process to separate the pure polyol from the organic solvent used in step c), preferably an organic solvent is selected with a boiling point at ambient pressure below 200° C., more preferably below 150° C.

In one embodiment, the organic solvent is selected from aliphatic hydrocarbons, halogenated hydrocarbons, ethers, aromatic hydrocarbons, esters, ketones and mixtures thereof.

Suitable halogenated hydrocarbons are selected from dichloromethane, chloroform, 1,2-dichloroethane, 1,1,1-trichloroethane, 1,1,2,2-tetrachloroethane, chlorobenzene and mixtures thereof.

Therefore, according to a further embodiment, the present invention is also directed to the process as disclosed above, wherein the organic solvent (S1) is selected from the group consisting of aliphatic hydrocarbons, halogenated hydrocarbons, ethers, aromatic hydrocarbons, aromatic halogenated hydrocarbons esters, ketones and mixtures thereof.

If desired, mixtures of two or more of the afore-mentioned organic aprotic solvents may be used.

This step is typically carried out at elevated reaction temperatures of at least 0° C. but generally not higher than 150° C. to, preferably from 10 to 100° C.

The process of the invention further comprises step d). According to step d), HCl is added to precipitate the pMDA as it's HCl salt and separation of the pMDA-HCl is performed.

According to the present invention, HCl may be added as a gas or a solution of HCl in any of the given solvents suitable for step c). The ratio of the HCl used preferably is at least one equivalent of HCl per equivalent of pMDA and up to 100 equivalents HCl per equivalent of pMDA.

Unreacted HCl can also be recycled afterwards from the polyol phase e.g. via distillation or flashing.

Therefore, according to a further embodiment, the present invention is also directed to the process as disclosed above, wherein HCl is added as a gas or a solution of HCl in solvent (S1).

If solvents are used in this step at temperatures above their boiling point at ambient pressure or under HCl pressure, the extraction occurs in a pressure vessel, e.g. an autoclave at the then given vapor pressure of the used solvent at the chosen extraction temperature.

Preferably, this step is carried out at elevated reaction temperatures of at least 0° C. but not higher than 150° C. to, more preferably from 10 to 100° C.

The inventive process for separating the so formed solid pMDA-HCl may be carried out in customary devices and/or known to the person skilled in the art for the separation of a solid from a liquid. For the inventive process, it is in principle possible to use any equipment which is fundamentally suitable for the separation of a solid from a liquid at the stated temperatures and the stated pressures like filtration, decanting or centrifuging. Suitable equipment for filtrations is for example disclosed in Filtration, 2. Equipment, in Ullmann's Encyclopedia of Industrial Chemistry, 2013, Wiley-VCH Verlag GmbH & Co. KGaA, DOI 10.1002/1436007.n11_n01.pub2.

The filtration may be carried out discontinuously in batch mode or continuously, semi-continuously.

After separation of the pMDA-HCl salt, the liquid phase with the organic solvent added in step c) typically contains the polyol component and if in excess used also HCl. The HCl and organic solvent can then be separated from the polyol by distillation and the polyol component be reused in the synthesis of new polyurethane rigid foams, whereas the organic solvent can be reused in step c) and HCl can be reused in step d).

After the separation, the pMDA-HCl may be further purified. Suitable purification steps may include washing with fresh solvents to remove traces of polyol and/or drying under elevated temperatures and/or in vacuo.

Preferably, the process of the present invention comprises step d1):
d1) purification of the pMDA-HCl salt by washing with fresh solvents and/or drying under elevated temperatures and/or drying in vacuo.

The pMDA-HCl salt may be isolated but may also be subjected to further steps such as for example phosgenation to obtain pMDI which in turn may be isolated and used for further processes.

Preferably, the process of the present invention comprises step e):
e) phosgenation of pMDA HCl salt to obtain pMDI.

In step e) according the present invention the pure pMDA-HCl salt obtained in step d) of step d1) can in one embodiment then directly be used as starting material in the phosgenation to produce new pMDI. Suitable conditions for phosgenation are in principle known to the person skilled in the art. The phosgenation of amine-HCl salts is for example disclosed in U.S. Pat. No. 8,455,695, EP0424836A1 or CN107337615B.

According to an alternative embodiment, the pMDA-HCl salt obtained may also be reacted with formaldehyde. Thus, the process of the present invention may also comprise step e*):
e*) condensation reaction of the pMDA HCl salt with formaldehyde, preferably with formaldehyde and anilin, to obtain pMDA.

According to this embodiment, the isolated pMDA-HCl salt is used in a condensation reaction of aniline with formaldehyde to obtain fresh pMDA which can then be reused in the state-of-the-art phosgenation for the production of pMDI as for example described in: Isocyanates, Organic, in Ullmann's Encyclopedia of Industrial Chemistry, 2012, DOI: 10.1002/14356007.a14_611.

According to a further aspect, the present invention is also directed to a polymeric methylene phenylene amine (pMDA) obtained or obtainable according to a process as disclosed above.

According to an aspect, the present invention is also directed to a polymeric methylenediphenyl diisocyanate (pMDI) obtained or obtainable according to a process as disclosed above.

The polymeric methylenediphenyl diisocyanate (pMDI) obtained or obtainable according to the process of the present invention may be reused as a starting material, for example in processes for the preparation of polyurethanes or polyisocyanurates.

According to a further aspect, the present invention is also directed to the use of the polymeric methylenediphenyl diisocyanate (pMDI) obtained or obtainable according to the process of the present invention or a polymeric methylenediphenyl diisocyanate (pMDI) according to the present invention for the preparation of polyurethanes or polyisocyanurates.

Further embodiments of the present invention can be found in the claims and the examples. It will be appreciated that the features of the subject matter/processes/uses according to the invention that are mentioned above and elucidated below are usable not only in the combination specified in each case but also in other combinations without departing from the scope of the invention. For example, the combination of a preferred feature with a particularly preferred feature or of a feature not characterized further with a particularly preferred feature etc. is thus also encompassed implicitly even if this combination is not mentioned explicitly.

Illustrative embodiments of the present invention are listed below, but these do not restrict the present invention. In particular, the present invention also encompasses those embodiments which result from the dependency references and hence combinations specified hereinafter.
1. A value chain return process comprising the steps of
   a) depolymerization of a polyurethane and polyisocyanurate rigid foam based on polymeric methylenediphenyl diisocyanate (pMDI) to give a mixture (M1);
   b) distillative removal of volatile compounds from mixture (M1) to give a mixture (M2) comprising pMDA and at least one polyol;
   c) dissolution of the mixture (M2) in an aprotic organic solvent (S1) with a dipol moment in the range from 0.5*10⁻³⁰ Cm to 7.8*10⁻³⁰ Cm;
   d) addition of HCl and separation of the pMDA-HCl salt.
2. The process according to embodiment 1, wherein the process comprises step e)
   e) phosgenation of pMDA HCl salt to obtain pMDI.
3. The process according to embodiment 1 or 2, wherein the process comprises further purification steps.
4. The process according to any one of embodiments 1 to 3, wherein the process comprises a step d1)
   d1) purification of the pMDA-HCl salt by washing with fresh solvents and/or drying under elevated temperatures and/or drying in vacuo.
5. The process according to any of embodiments 1 to 3, wherein the process comprises step e*)
   e*) condensation reaction of the pMDA HCl salt with formaldehyde, preferably with formaldehyde and anilin, to obtain pMDA.
6. The process according to any of embodiments 1 to 5, wherein in step a) depolymerization is achieved via a hydrolysis in the presence of a catalytic active organic nitrogen component.
7. The process according embodiment 6, wherein the catalytic active organic nitrogen compound is selected from the group consisting of pyridine, 1-methylimdazole and triethylamine.
8. The process according to any of embodiments 1 to 7, wherein step b) is carried out at a pressure in the range of from 1 bar to 0.001 bar and a temperature in the range of from 20° C. to 250° C.
9. The process according to any of embodiments 1 to 8, wherein the aprotic organic solvent (S1) is selected from the group consisting of aliphatic hydrocarbons, halogenated hydrocarbons, ethers, aromatic hydrocarbons, esters, ketones and mixtures thereof.
10. The process according to any of embodiments 1 to 9, wherein HCl is added as a gas or a solution of HCl in solvent (S1).
11. Polymeric methylene phenylene amine (pMDA) obtained or obtainable according to a process of any of embodiments 1 to 10.
12. Polymeric methylenediphenyl diisocyanate (pMDI) obtained or obtainable according to a process of any of embodiments 1 to 10.
13. Use of the polymeric methylenediphenyl diisocyanate (pMDI) obtained or obtainable according to a process of any of embodiments 1 to 10 or a polymeric methylenediphenyl diisocyanate (pMDI) according to 12 for the preparation of polyurethanes or polyisocyanurates.
14. A value chain return process comprising the steps of
   a) depolymerization of a polyurethane and polyisocyanurate rigid foam based on polymeric methylenediphenyl diisocyanate (pMDI) to give a mixture (M1);
   b) distillative removal of volatile compounds from mixture (M1) to give a mixture (M2) comprising pMDA and at least one polyol;
   c) dissolution of the mixture (M2) in an aprotic organic solvent (S1) with a dipol moment in the range from 0.5*10⁻³⁰ Cm to 7.8*10⁻³⁰ Cm;
   d) addition of HCl and separation of the pMDA-HCl salt,
   e) phosgenation of pMDA HCl salt to obtain pMDI.
15. A value chain return process comprising the steps of
   a) depolymerization of a polyurethane and polyisocyanurate rigid foam based on polymeric methylenediphenyl diisocyanate (pMDI) to give a mixture (M1);
   b) distillative removal of volatile compounds from mixture (M1) to give a mixture (M2) comprising pMDA and at least one polyol;
   c) dissolution of the mixture (M2) in an aprotic organic solvent (S1) with a dipol moment in the range from 0.5*10⁻³⁰ Cm to 7.8*10⁻³⁰ Cm;
   d) addition of HCl and separation of the pMDA-HCl salt,
   wherein the process comprises a step d1)
   d1) purification of the pMDA-HCl salt by washing with fresh solvents and/or drying under elevated temperatures and/or drying in vacuo.
16. A value chain return process comprising the steps of
   a) depolymerization of a polyurethane and polyisocyanurate rigid foam based on polymeric methylenediphenyl diisocyanate (pMDI) to give a mixture (M1);
   b) distillative removal of volatile compounds from mixture (M1) to give a mixture (M2) comprising pMDA and at least one polyol;
   c) dissolution of the mixture (M2) in an aprotic organic solvent (S1) with a dipol moment in the range from 0.5*10⁻³⁰ Cm to 7.8*10⁻³⁰ Cm;
   d) addition of HCl and separation of the pMDA-HCl salt,
   wherein the process comprises step e*)
   e*) condensation reaction of the pMDA HCl salt with formaldehyde, preferably with formaldehyde and anilin, to obtain pMDA.
17. A value chain return process comprising the steps of
   a) depolymerization of a polyurethane and polyisocyanurate rigid foam based on polymeric methylenediphenyl diisocyanate (pMDI) to give a mixture (M1);
   b) distillative removal of volatile compounds from mixture (M1) to give a mixture (M2) comprising pMDA and at least one polyol;
   c) dissolution of the mixture (M2) in an aprotic organic solvent (S1) with a dipol moment in the range from 0.5*10⁻³⁰ Cm to 7.8*10⁻³⁰ Cm;
   d) addition of HCl and separation of the pMDA-HCl salt,
   e) phosgenation of pMDA HCl salt to obtain pMDI,
   wherein in step a) depolymerization is achieved via a hydrolysis in the presence of a catalytic active organic nitrogen component.
18. The process according embodiment 17, wherein the catalytic active organic nitrogen compound is selected from the group consisting of pyridine, 1-methylimdazole and triethylamine.
19. The process according to any of embodiments 14 to 18, wherein step b) is carried out at a pressure in the range of from 1 bar to 0.001 bar and a temperature in the range of from 20° C. to 250° C.
20. The process according to any of embodiments 14 to 19, wherein the aprotic organic solvent (S1) is selected from the group consisting of aliphatic hydrocarbons, halogenated hydrocarbons, ethers, aromatic hydrocarbons, esters, ketones and mixtures thereof.
21. The process according to any of embodiments 14 to 20, wherein HCl is added as a gas or a solution of HCl in solvent (S1).

The present invention can be further explained and illustrated on the basis of the following examples. However, it will be understood that these examples are included merely for purposes of illustration and are not intended to limit the scope of the invention in any way.

### EXAMPLES

1. Materials used
Polyol 1: polyetherol, obtained by propoxylation of propylenglycol with an OH number of 56.
Polyol 2: polyetherol, obtained by propoxylation of propylenglycol with an OH number of 248.
Polyol 3: polyetherol, obtained by propoxylation of glycerin with an OH number of 42.
Polyol 4: polyetherol, obtained by propoxylation of glycerin with an OH number of 400.
Polyol 5: polyetherol, obtained by propoxylation of toluoldiamine with an OH number of 400.
Polyol 6: polyetherol, obtained by propoxylation of sorbitol with an OH number of 490.
Polyol 7: polyetherol, obtained by propoxylation of a mixture of saccharose and glycerin with an OH number of 490.
Elastopir: polyisocyanurate rigid foam from BASF Polyurethanes obtained by reacting a polyol component (Elastopir 1132/509) containing P-containing flame retardant with Lupranat M50 (Index=330).
Elastocool polyurethane rigid foam from BASF Polyurethanes obtained by reacting a polyol component (Elastocool F 2030/310) with Lupranat M20 (Index=120).

In the extraction experiments, different pMDI based PU rigid foams were used. PU rigid foam Elastopir is based on 70% of polymeric-MDI and 30% of the Polyole component (polyestheroles and polyetherole mixtures). PU rigid foam Elastocool is based on 60% pMDI and 40% of propylenoxide based poyletherols. PU Rigid Foam “End-of-life Polymer” is material which was used as insulation in refrigerators. The composition was not exactly known, but it is a common polyurethane rigid foam used for this applications, which be made mainly from pMDI and shorter chain polyether- and polyesterols. By the hydrolysis and separation of the pMDA-HCl, this could be confirmed in a reverse-engineering way by applying the process according to the invention.

2. Precipitation of Polymeric Diaminodiphenylmethan (pMDA) with HCl.

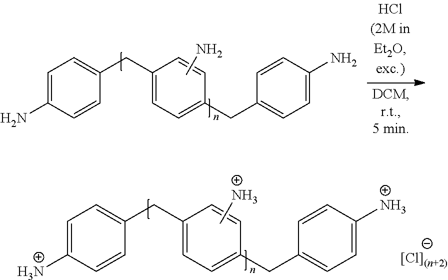

Polymeric MDA (368 mg, 1.86 mmol) was weighed into a 20 mL vial. The walls were rinsed with CH₂Cl₂ (5 mL). Under stirring, an ethereal solution of HCl (2 M in Et₂O, 5 mL) was added to the yellow solution. The formation of a thick precipitate could immediately be observed. [Note: the last 3 mL of the solution were directly injected into the solution to ensure contact with the DCM phase.] After closing with a screw cap, the vial was additionally shaken to homogeneously mix all phases. The suspension was filtered over a suction filter and the remaining solid was washed with DCM (3×5 mL) and Et₂O (2×2 mL). After drying in air for 20 minutes, the yellow solid was transferred to a flask for additional drying overnight under reduced pressure (r.t., 2.0-10⁻² mbar). A highly electrostatic solid (502 mg, 1.85 mmol, >99%) was obtained. The colorless filtrate was dried under reduced pressure (45° C., 70 mbar). No residue was detected in the flask.

3. Separation of Polymeric-Diaminodiphenylmethane (pMDA) from Polyols in Pre-Mixed Samples by Precipitation with HCl.

Table 1 summarizes the obtained results. Polymeric 4,4′-diaminodiphenyl methane and polyol were mixed in a 20 mL screw cap vial. Each sample was either dissolved in the indicated amount of dichloromethane. After homogeneous mixing, the indicated amount of an ethereal HCl (2 M in Et₂O) was added. The samples were diluted with the indicated amount of dichloromethane and mixed by shaking for 20 seconds. A lot of precipitate could be observed for each sample. All samples were filtered over a suction filter. The remaining solid was washed with dichloromethane (3×10 mL) and dried for five hours at 60° C. (oven), yielding polymeric 4,4′-diaminodiphenyl methane as polyhydrochloride salt. The solvent of all filtrates was removed under reduced pressure (47° C., minimal pressure 60 mbar). Masses of all fractions can be withdrawn from the following table. All samples were analyzed by ¹H & ¹³C NMR spectroscopy (MeOD-d₄ for hydrochloride salts, CdCl₃ for polyols).

TABLE 1
Separation of polymeric 4,4′-diaminodiphenylmethane (pMDA)
from polyols in pre-mixed samples by precipitation with HCl.^{[1]}

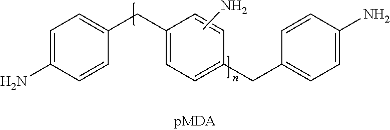

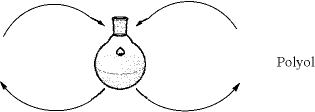

| | | | | HCl | pMDA- | |
|---|---|---|---|---|---|---|
| | pMDA | polyol | DCM^{[1]} | (2 M) | HCl^{[2]} | polyol |
| # | [g] | [g] | [mL] | [mL] | [g] | [g] |
| 1 | 0.338 | Polyol 1 | 3 + 2 | 4 | 0.460 | 0.303 |
| | | 0.311 | | | | |
| 2 | 0.314 | Polyol 2 | 3 + 2 | 4 | 0.394 | 0.367 |
| | | 0.371 | | | | |
| 3 | 0.304 | Polyol 3 | 3 + 2 | 4 | 0.439 | 0.274 |
| | | 0.307 | | | | |
| 4 | 0.307 | Polyol 4 | 3 + 2 | 4 | 0.440 | 0.379 |
| | | 0.390 | | | | |
| 5 | 0.265 | Polyol 5 | 3 + 2 | 5 | 0.430^{[3]} | 0.209 |
| | | 0.264 | | | | |
| 6 | 0.474 | Polyol 6 | 3 + 2 | 5 | 0.679^{[3]} | 0.225 |
| | | 0.258 | | | | |
| 7 | 0.308 | Polyol 7 | 3 + 2 | 4 | 0.460^{[3]} | 0.253 |
| | | 0.303 | | | | |

^{[1]}amount of DCM used for dissolution + amount of DCM used for dilution
^{[2]}isolated as polyhydrochloride salt
^{[3]}the sample contains minor amounts of polyol

4. Separation of Monomer Mixtures Obtained by Hydrolysis in an Amine Base-Water Mixture Followed by Precipitation of Polymeric Diaminodipheny/Methane from Polyols with HCL

Table 2 summarizes the obtained results. In air, a 38 mL ace-tube was charged with polymer. The walls were rinsed with amine base and water. The tube was closed and heated overnight to 160° C. under stirring. After stirring for 18 hours at 160° C. the dark-orange solution was cooled to room temperature. The sample was filtered over a small pad of Celite (Pasteur pipette) and the pad was rinsed with the used amine base (3×4 mL). The solvent was removed under reduced pressure (in case of pyridine: 47° C., minimal pressure 60 mbar; in case of methylimidazole: 90° C., minimal pressure 1.8-10⁻² mbar). The residue was suspended in dry dichloromethane (20 mL for small scale reactions [1.00 g]; 150 mL for bigger scale reactions). The indicated amount of an ethereal solution of HCl was added at room temperature under stirring. The formation of a heavy precipitate could be observed. After stirring for five minutes at room temperature. The solid was filtered over a suction filter, washed with additional dry dichloromethane (3×10 mL) and dried under reduced pressure (r.t., 1.8.10⁻² mbar). The dried solid was weighed and determined the amount of isolated ammonium polyhydrochloride salt. The solvent of the filtrate was removed under reduced pressure (47° C., minimal pressure 50 mbar) and the residual oil determined the polyol fraction. All products were characterized by ¹H and ¹³C NMR.

TABLE 2
Separation of monomer mixtures obtained by hydrolysis in an amine base-water mixture followed by precipitation of polymeric 4,4'-diaminodi-
phenylmethane from polyols with HCl.^{[1]}

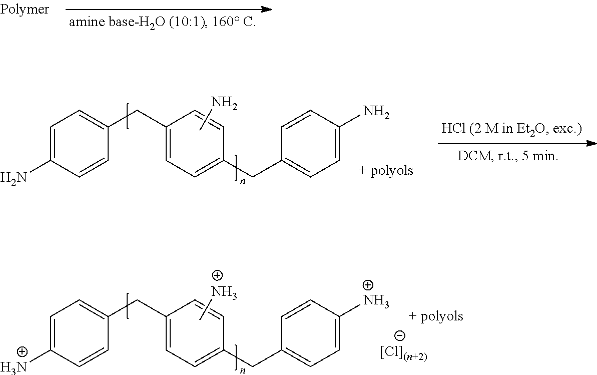

| | PU rigid foam | amine base | water | HCl (2 M) | conversion | polyol | ammonium HCl |
|---|---|---|---|---|---|---|---|
| # | [g] | [mL] | [mL] | [mL] | [%] | [g] | [g] |
| 1 | Elastopir | Py | 2 | 5 | >99 | 0.124 | 0.808 |
| | 0.905 | 20 | | | | | |
| 2 | Elastopir | MIM | 2 | 5 | >99 | 0.189 | 0.847 |
| | 0.911 | 20 | | | | | |
| 3^{[2]} | Elastopir | MIM | 8 | 50 | >99 | 1.55 | 6.62 |
| | 7.70 | 80 | | | | | |
| 4 | Elastocool | Py | 2 | 5 | >99 | 0.234 | 0.753 |
| | 0.914 | 20 | | | | | |
| 5^{[2]} | Elastocool | MIM | 10 | 50 | >99 | 3.46 | 6.40 |
| | 9.90 | 100 | | | | | |
| 6 | End-of-Life polymer | Py | 1 | 6 | 95%^{[3]} | 0.303 | 0.705 |
| | 1.00 | 10 | | | | | |
| 7 | End-of-Life polymer | MIM | 1 | 6 | 96%^{[3]} | 0.270 | 0.638 |
| | 1.00 | 10 | | | | | |

^{[1]}Py = pyridine; MIM = methylimidazole
^{[2]}the experiment was performed inside a stainless-steel autoclave (Premex) fitted with a Teflon insert
^{[3]}the used polymer contained non-hydrolysable components e.g., iron particles.

5. Solubility of Polymeric Diamimoniumiphenylmethane Polyhydrochloride (pMDA·HCl and Polyol 7 in different solvents:

A 20 mL vial was charged with either pMDA·HCl (˜20-40 mg) or Polyol 7 (50-100 mg). The indicated solvent (3-4 mL) was added and the vial was closed. All vials were shaken for approximately one minute after being left standing for four hours at room temperature. Solubility of all samples was checked on the same day as well as after standing over the weekend at room temperature (total of 68 hours).

| Solvent | | |
|---|---|---|
| (Dipolmoment | | |
| in *10⁻³⁰ Cm) | pMDA•HCl | Polyol 7 |
| Cyclohexane | insoluble | insoluble |
| (0, 0) | | |
| Hexane (0, 0) | insoluble | insoluble |
| THF (5, 8) | insoluble | soluble |
| Dioxane (1, 5) | insoluble | soluble |
| Toluene (1, 4) | insoluble | soluble |
| EtOAc (6, 3) | insoluble | soluble |
| MeOH (5, 7) | soluble | soluble |
| EtOH (5, 8) | soluble | soluble |
| iPrOH (5, 5) | partially soluble | soluble |
| n-BuOH (5, 8) | partially soluble after 4 hours | soluble |
| | soluble after 68 hours | |
| DMF (12, 9) | soluble | soluble |
| Pyridine (7, 9) | soluble | soluble |

### STATE OF THE ART CITED

Kunststoffhandbuch, Band 7, Polyurethane, Carl-Hanser-Verlag, 3. Auflage, 1993, Kapitel 6 Plastics recycling and Polyurethanes, in Ullmann's Encyclopedia of Industrial Chemistry, 2020, DOI: 10.1002/14356007.a21_057.pub2 and Waste Management, 2018, 76, 147-171
DE 2854940A1
ChemSusChem, 2021, DOI: 10.1002/cssc.202101705
WO 2015/121057
WO 2013/139781
Ullmann's Encyclopedia of Industrial Chemistry, 2012, DOI: 10.1002/14356007.a21_665.pub2
U.S. Pat. No. 8,455,695
EP0424836A1
CN107337615B

1: A value chain return process, comprising:
a) depolymerizing a polyurethane and polyisocyanurate rigid foam based on polymeric methylenediphenyl diisocyanate (pMDI) to give a mixture (M1);
b) performing distillative removal of volatile compounds from mixture (M1) to give a mixture (M2) comprising pMDA and at least one polyol;
c) dissolving the mixture (M2) in an aprotic organic solvent (S1) with a dipole moment of 0.5*10⁻³⁰ Cm to 7.8*10⁻³⁰ Cm; and
d) adding HCl and separating the pMDA-HCl salt;
wherein depolymerizing comprises performing hydrolysis in the presence of a catalytic active organic nitrogen component.

2: The process according to claim 1, further comprising:
e) performing phosgenation of the pMDA HCl salt to obtain pMDI.

3: The process according to claim 1, further comprising purifying.

4: The process according to claim 2, further comprising:
d1) purifying the pMDA-HCl salt by washing with fresh solvents and/or drying under elevated temperatures and/or drying in vacuo.

5: The process according to claim 1, further comprising:
e*) performing a condensation reaction of the pMDA HCl salt with formaldehyde to obtain pMDA.

6. (canceled)

7: The process according claim 1, wherein the catalytic active organic nitrogen compound is selected from the group consisting of pyridine, 1-methylimdazole, and triethylamine.

8: The process according to claim 1, wherein distillative removal of volatile compounds is carried out at a pressure of 1 bar to 0.001 bar and a temperature of 20° C. to 250° C.

9: The process according to claim 1, wherein the aprotic organic solvent (S1) is at least one selected from the group consisting of an aliphatic hydrocarbon, a halogenated hydrocarbon, an ether, an aromatic hydrocarbon, an ester, and a ketone.

10: The process according to claim 1, wherein HCl is added as a gas or a solution of HCl in solvent (S1).

11: A polymeric methylene phenylene amine (pMDA) obtained by the process of claim 1.

12: A polymeric methylenediphenyl diisocyanate (pMDI) obtained by the process of claim 1.

13: A method for preparing polyurethanes or polyisocyanurates, comprising reacting the polymeric methylenediphenyl diisocyanate according to claim 12.
